(19) United States
(12) Patent Application Publication
(10) Pub. No.: US 2019/0196184 A1
(43) Pub. Date: Jun. 27, 2019

(54) DISPLAY SYSTEM

(71) Applicant: ALPINE ELECTRONICS, INC., Tokyo (JP)

(72) Inventors: Akihiko Takizawa, Iwaki-shi (JP); Hidetoshi Kadoya, Tokyo (JP); Takaki Okino, Iwaki-shi (JP)

(73) Assignee: ALPINE ELECTRONICS, INC., Tokyo (JP)

(21) Appl. No.: 16/210,541

(22) Filed: Dec. 5, 2018

(30) Foreign Application Priority Data
Dec. 27, 2017 (JP) 2017-251889

(51) Int. Cl. G02B 27/01; B60R 11/02; G06K 9/00

(52) U.S. Cl. CPC G02B 27/0101; B60R 2300/205; G06K 9/00805; B60R 11/0229

(57) ABSTRACT

In a display system, a HUD displays a virtual marker D indicating a vehicle shape which guides a traveling direction of a user's vehicle. The display system measures an inter-vehicle distance between the user's vehicle and a forward vehicle and determines a display position and a display size of the virtual marker in accordance with the inter-vehicle distance. The virtual marker is shifted to a near side of the user's vehicle when the inter-vehicle distance is small, whereas the virtual marker is shifted to a far side of the user's vehicle when the inter-vehicle distance is large. A portion of the virtual marker is brought into a non-display state as if the portion is absorbed into the user's vehicle when the inter-vehicle distance is reduced, and the virtual marker is not displayed when the distance is further reduced.

### RELATED APPLICATION

The present application claims priority to Japanese Patent Application Number 2017-251889, filed Dec. 27, 2017, the entirety of which is hereby incorporated by reference.

### BACKGROUND

### 1. Field of the Invention

The present invention relates to a display system utilizing a head-up display, and particularly relates to a system which displays a virtual marker for directing or guiding a user's vehicle.

### 2. Description of the Related Art

As a method for displaying information to be used for assisting a driver, a head-up display (HUD) has been used in practice. A typical HUD projects an image on the windshield or an installed screen using a projection apparatus installed in a vehicle, and a driver may visually recognize a virtual image projected as if an object exists in a real space beyond the windshield. Use of the HUD enables display of driving support information in the viewing direction, and therefore, a shift of the viewing direction of the driver may be reduced when compared with a case where the driver views a liquid crystal display or the like in a vehicle.

According to Japanese Unexamined Patent Application Publication No. 2016-182891, when a lane change is to be made while a virtual vehicle of the user's vehicle is displayed by the HUD, for example, the virtual vehicle which travels on an image of an arrow mark indicating a driving course is displayed as a moving image so that a driving direction of the user's vehicle is visually displayed beforehand for the driver.

A general problem which arises when a virtual marker is displayed by the HUD will now be described. A virtual marker is displayed to guide the user's vehicle in a traveling direction. A virtual marker 20 having a vehicle shape is projected on the windshield as illustrated in FIG. 8A, for example, and a driver may visually recognize a virtual image of the virtual marker 20 which overlaps with a real space in the viewing direction. The virtual marker 20 may be operated in combination with a navigation function, for example, so as to display a traveling direction, such as a right/left turn at an intersection or a lane change. The driver expects a traveling direction of the vehicle by watching a movement of the virtual marker 20 displayed on a front portion of the driver's vehicle. In particular, in a case when vision is not clear, such as a case of traveling at night or in bad weather, the virtual marker 20 is useful information for the driver.

If a distance between a forward vehicle X and the user's vehicle is constant, the driver may visually recognize the virtual marker 20 positioned between the forward vehicle X and the user's vehicle. However, if an inter-vehicle distance between the user's vehicle and the forward vehicle becomes small, the driver visually recognizes the virtual marker 20 in a position which overlaps with the forward vehicle, and therefore, the virtual marker 20 is difficult to be viewed. To avoid this situation, visibility of the virtual marker 20 may be ensured by moving a display position of the virtual marker 20 sideward as illustrated in FIG. 8B. However, when such a process is performed, the driver may mistakenly recognize that the vehicle is traveling sideward along with the movement of the virtual marker 20 or the driver may be confused about focusing on the forward vehicle X or the virtual marker 20.

### SUMMARY

The present disclosure is made in view of the foregoing problem and an object of the present disclosure is to provide a display system having improved visibility of a virtual marker.

A display system according to the present disclosure includes a detector configured to detect a forward vehicle which is traveling in front of the user's vehicle, a measurement unit configured to measure an inter-vehicle distance between the user's vehicle and the forward vehicle, a projection unit configured to project an image of a virtual marker which guides a traveling direction of the user's vehicle on a windshield of the user's vehicle, and a controller configured to control the projection unit such that a display position of a virtual image of the virtual marker is changed depending on the inter-vehicle distance.

According to one embodiment, the controller may shift a display position of the virtual image of the virtual marker toward a near side as the inter-vehicle distance is reduced. According to another embodiment, the controller may not display a portion of the virtual image of the virtual marker when the inter-vehicle distance becomes equal to or smaller than a first value. According to a still another embodiment, the controller may not display a portion of the virtual image of the virtual marker which overlaps with the user's vehicle. According to a further embodiment, the controller may not display the entire virtual image of the virtual marker when the inter-vehicle distance becomes equal to or smaller than a second value which is smaller than the first value. According to a still further embodiment, the controller may change a size of the virtual marker in a step-by-step manner in accordance with the inter-vehicle distance. According to a further embodiment, the controller may determine the size of the virtual marker based on a size of the forward vehicle detected by the detector. According to a further embodiment, the controller may not display the virtual image of the virtual marker irrespective of the inter-vehicle distance when the user's vehicle is stopped. According to a further embodiment, the virtual marker may be an image indicating a vehicle shape, and a rear portion of the vehicle shape may not be displayed. According to a further embodiment, the display system may further include a detector configured to detect a viewing direction or a face direction of a driver. The controller may control a position where the virtual image of the virtual marker is displayed based on a result of the detection performed by the detector.

### BRIEF DESCRIPTION OF THE DRAWINGS

FIG. 1 is a block diagram illustrating a configuration of a display system according to an embodiment of the present invention;

FIG. 2 is a diagram illustrating an example of a configuration of a HUD according to the embodiment of the present invention;

FIG. 3 is a diagram illustrating a functional configuration of a display control program according to the embodiment of the present invention;

FIG. 4A is a diagram illustrating an example of display of a virtual marker by the HUD according to the embodiment;

FIG. 4B is a side view schematically illustrating the relationship between a position where the virtual marker is displayed and an inter-vehicle distance according to the embodiment;

FIGS. 5A and 5B are diagrams illustrating an example of display of the virtual marker when the inter-vehicle distance is gradually reduced in the display system according to this embodiment;

FIGS. 6A and 6B are diagrams illustrating the example of the display of the virtual marker when the inter-vehicle distance is gradually reduced in the display system according to this embodiment;

FIGS. 7A and 7B are diagrams illustrating an example of display of a virtual marker according to another embodiment of the present invention; and

FIGS. 8A and 8B are diagrams illustrating a problem which arises when a conventional virtual marker is displayed.

### DETAILED DESCRIPTION OF THE PREFERRED EMBODIMENTS

A display system according to the present disclosure includes an image projection apparatus represented by a HUD and has a function of projecting or emitting various images on a front windshield or a screen of a vehicle by the HUD. A driver may visually recognize a virtual image projected by the HUD on the windshield in a viewing direction.

### Embodiment

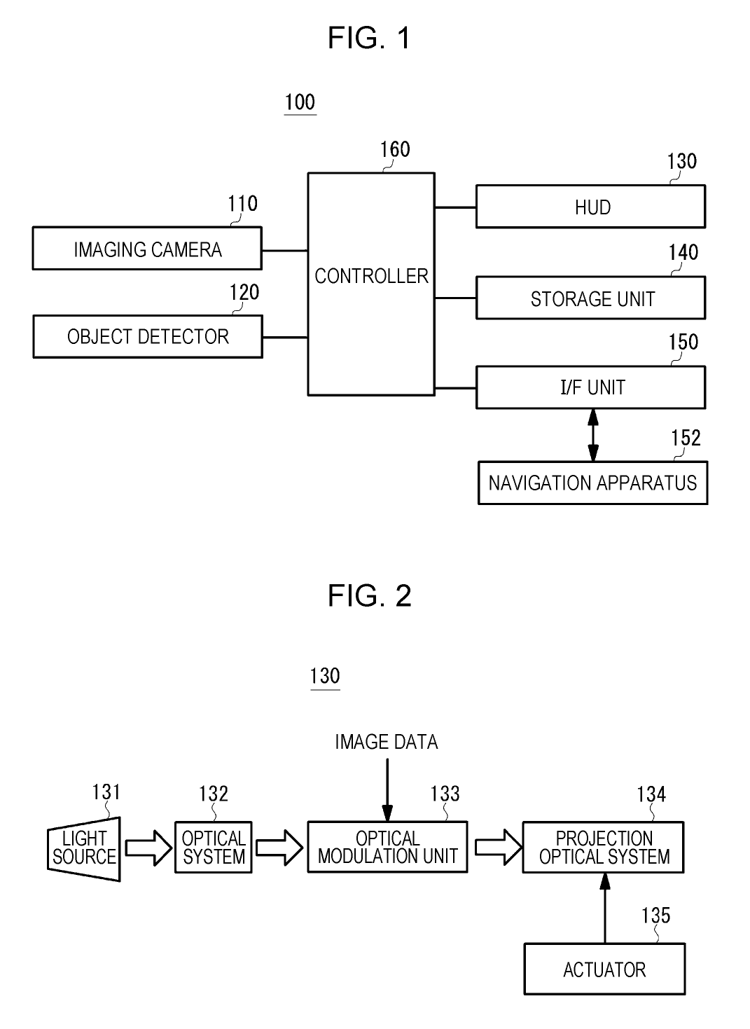

Next, an embodiment of the present invention will be described with reference to the accompanying drawings. FIG. 1 is a block diagram illustrating a configuration of a display system according to the embodiment of the present invention. A display system 100 of this embodiment includes an imaging camera 110, an object detector 120, a HUD 130, a storage unit 140, an I/F unit 150, and a controller 160.

The imaging camera 110 includes at least one in-vehicle camera which images an area in front of the user's vehicle. The imaging camera 110 images a forward vehicle which is traveling in front of the user's vehicle and transmits data on the captured image to the controller 160. The image data is used for detection of the forward vehicle which is traveling in front of the user's vehicle and a determination of a type (such as a private car, a truck, or a bus) or a size of the forward vehicle. Furthermore, the imaging camera 110 may be a stereo camera, and in this case, a distance to the forward vehicle imaged by the stereo camera may be measured.

The imaging camera 110 may image an interior space of the user's vehicle and image a face of a driver. In this case, the imaging camera 110 is disposed in the vicinity of a steering wheel or inside an instrument panel. The image data captured by the imaging camera 110 is supplied to the controller 160 which may detect the viewing direction of the driver or a direction of the face of the driver.

The object detector 120 detects presence or absence of an object near the user's vehicle, a distance to such an object, and the like. Examples of the object detector 120 include a millimeter-wave radar and an infrared laser.

The HUD 130 projects an image on the front windshield glass of the user's vehicle or a screen so as to display a virtual image projected in the viewing direction of the driver. FIG. 2 is a diagram illustrating an example of a configuration of the HUD 130. The HUD 130 includes a light source 131, an optical system 132 which collects light emitted from the light source 131, an optical modulation unit 133 which modulates light supplied from the optical system 132 based on image data, a projection optical system 134 which projects an image modulated by the optical modulation unit 133, and an actuator 135 which adjusts an optical axis, a focal length, or the like of the projection optical system 134.

The optical modulation unit 133 is constituted by a liquid crystal device or a digital mirror device (DMD) including a plurality of variable mirrors disposed in a matrix, for example. The optical modulation unit 133 generates a projection image which has been optically modulated based on image data supplied from the controller 160. The controller 160 supplies image data of 30 frames or 60 frames per second to the optical modulation unit 133, for example, and the optical modulation unit 133 generates a projection image based on the consecutive image data.

In this embodiment, the controller 160 supplies image data for a virtual marker indicating a shape of a vehicle to the optical modulation unit 133, and the projection optical system 134 projects an image modulated based on the image data for the virtual marker on the windshield. When the display system 100 is connected to a navigation apparatus 152 through the I/F unit 150, the HUD 130 projects an image generated based on image data for a virtual marker (for example, image data which guides intersections, a lane change, and a traveling speed) supplied from the navigation apparatus.

The projection optical system 134 including an optical member, such as a lens or a concave mirror, projects an image generated by the optical modulation unit 133 on the windshield. The actuator 135 adjusts a position of the lens or an angle of the mirror of the projection optical system 134, for example. According to an embodiment, the projection optical system 134 may adjust a focal length and an optical axis of the projection optical system 134 based on a control signal supplied from the controller 160 so as to vary a position and a size of a projected virtual image to be viewed by the driver. Note that the display system 100 may include a plurality of HUDs 130 which individually display projection images.

The storage unit 140 stores information required for the display system 100. The storage unit 140 may store the image data for a virtual marker projected by the HUD 130 and programs to be executed by the display system 100. According to an embodiment, the storage unit 140 may store various image data for virtual markers to be displayed in different display positions or to be displayed in different sizes so that the virtual markers are displayed in different forms depending on an inter-vehicle distance to the forward vehicle. Furthermore, the image data for a virtual marker may be image data defined on a three-dimensional coordinate instead of image data defined on a two-dimensional coordinate. The image data for a virtual marker includes at least a rear portion of the vehicle, and preferably indicates an entire vehicle from the rear portion to a front portion of the vehicle.

The I/F unit 150 enables connection between the display system 100 and an external apparatus. In this embodiment, a navigation apparatus 152 (or an electronic apparatus having a navigation function) is connected through the I/F unit 150. The navigation apparatus 152 has a function of calculating a position of the user's vehicle using a global positioning system (GPS) signal or a self-contained navigation sensor (such as an acceleration sensor or an angular rate sensor), a function of displaying data on a road map in a position near the user's vehicle, a function of retrieving a route from a present location to a destination, and guiding the vehicle along retrieved route. The display function of the navigation apparatus 152 may include a display device, such as a liquid crystal display device, separately from the HUD 130. When the navigation apparatus 152 is connected, the controller 160 may operate in combination with the navigation apparatus 152 and display a virtual marker which guides a traveling direction, such as a right/left turn at an intersection or a lane change, based on guide information supplied from the navigation apparatus 152 when the navigation apparatus 152 guides the route to the destination.

The controller 160 controls the various units included in the display system 100, preferably including a microcontroller including a read only memory (ROM) and a random access memory (RAM), and executes a display control program for controlling operation of the display system 100.

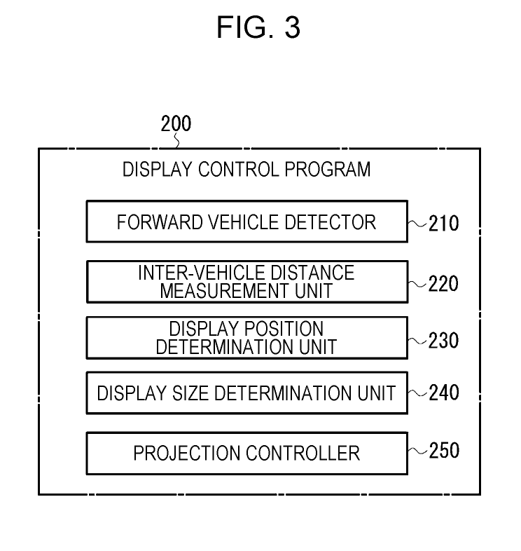

FIG. 3 is a diagram illustrating a functional configuration of the display control program according to this embodiment. A display control program 200 includes a forward vehicle detector 210, an inter-vehicle distance measurement unit 220, a display position determination unit 230, a display size determination unit 240, and a projection controller 250.

The forward vehicle detector 210 detects a forward vehicle which is traveling in front of the user's vehicle based on image data captured by the imaging camera 110 and a result of a detection performed by the object detector 120. According to an embodiment, the forward vehicle detector 210 determines a size and a vehicle type of the forward vehicle based on the captured image data.

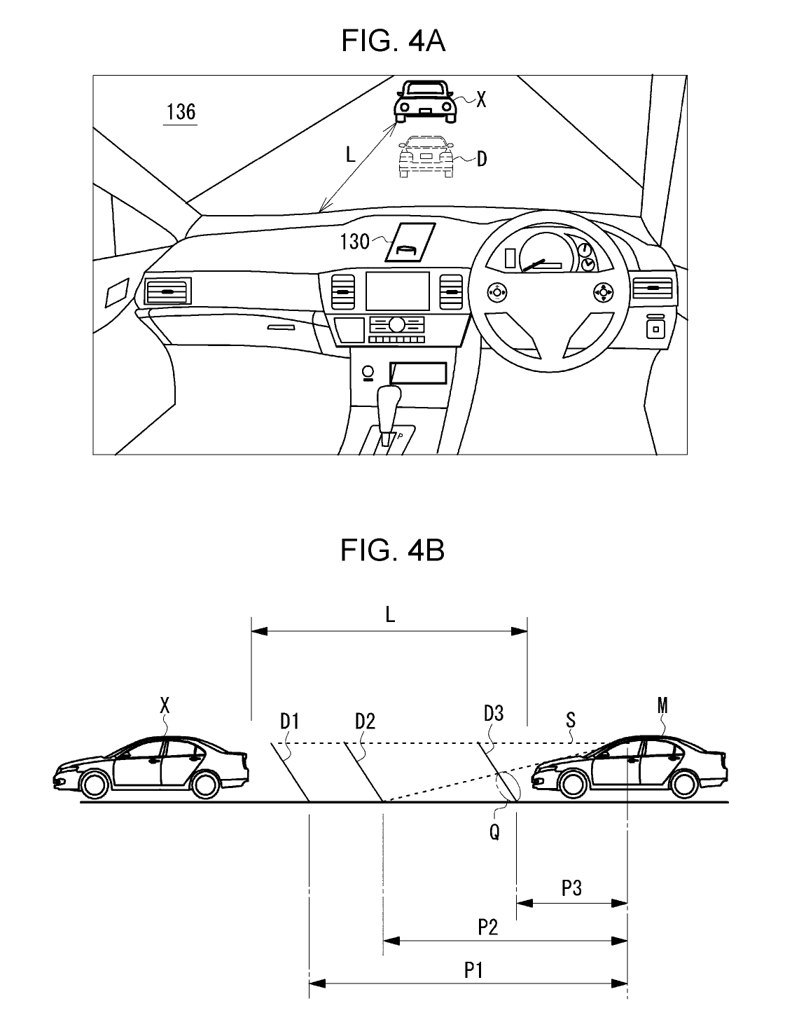

The inter-vehicle distance measurement unit 220 measures a distance between the user's vehicle and the forward vehicle which has been detected based on the result of the detection performed by the forward vehicle detector 210. For example, as illustrated in FIG. 4A, when a forward vehicle X is detected, the inter-vehicle distance measurement unit 220 measures a linear inter-vehicle distance L between the user's vehicle and the forward vehicle X. The inter-vehicle distance L may be calculated as a result of a detection performed by the infrared laser or the millimeter-wave radar of the object detector 120 or as a result of imaging performed by the stereo camera. The inter-vehicle distance measurement unit 220 repeatedly measures the inter-vehicle distance at a certain time interval while the forward vehicle is detected. On the other hand, the inter-vehicle distance measurement unit 220 does not measure an inter-vehicle distance when the forward vehicle detector 210 does not detect a forward vehicle.

The display position determination unit 230 determines a display position of the virtual marker based on the inter-vehicle distance measured by the inter-vehicle distance measurement unit 220. Here, the virtual marker is displayed in a position where the driver may view a virtual image D of the virtual marker projected on the front windshield glass in the real space in the viewing direction of the driver as illustrated in FIG. 4A. The display position determination unit 230 determines the display position of the virtual marker as follows. That is, the forward vehicle approaches the user's vehicle as the inter-vehicle distance is reduced, and therefore, the display position of the virtual marker shifts toward a near side such that the forward vehicle and the virtual marker do not overlap with each other. On the other hand, the forward vehicle moves away from the user's vehicle as the inter-vehicle distance is increased, and therefore, the display position of the virtual marker shifts toward a far side.

The relationship between the display position of the virtual marker and the inter-vehicle distance is illustrated in FIG. 4B. An inter-vehicle distance L between the user's vehicle M and a forward vehicle X is measured, and a virtual marker is displayed based on the inter-vehicle distance L. For example, the driver may view a virtual image D1 of the virtual marker in a distance P1 in a viewing direction S when the inter-vehicle distance is L1 and a virtual image D2 of the virtual marker in a distance P2 (P1>P2) when the inter-vehicle distance is L2 (L1>L2). That is, as the inter-vehicle distance is reduced, the display position of the virtual marker shifts toward the near side in a step-by-step manner. Thereafter, when the inter-vehicle distance is reduced to L3 which is further smaller than L2 and when a virtual image D3 of the virtual marker is viewed in a distance P3 (P2>P3), a portion Q in which the virtual image D3 of the virtual marker overlaps with the user's vehicle M is generated in the viewing direction S of the driver and the overlapping portion Q is not displayed. Accordingly, display is performed as if a rear portion of the virtual marker is absorbed into the user's vehicle. When the inter-vehicle distance becomes L4 which is smaller than L3 and which is equal to or smaller than a threshold value, the entire virtual image of the virtual marker overlaps with the user's vehicle, and therefore, the entire virtual image of the virtual marker is not displayed as if the entire virtual marker is absorbed into the user's vehicle. A position where the virtual image of the virtual marker overlaps with the user's vehicle in the viewing direction S of the driver is obtained in advance based on a shape of a hood or the like of the user's vehicle M, a height of the viewing direction of the driver, a size of the virtual marker, and the like. In a case where the display position of the virtual marker is changed in accordance with the inter-vehicle distance L, if the display position of the virtual marker reaches the position where the virtual image of the virtual marker overlaps with the user's vehicle, a portion or all of the virtual image of the virtual marker is not displayed.

When the inter-vehicle distance is gradually increased from the state in which the virtual image of the virtual marker is in the non-display state, the virtual image of the virtual marker is displayed as if the virtual marker is popped out from the user's vehicle. When a forward vehicle does not exist or when the inter-vehicle distance is equal to or larger than a certain threshold value, the display position of the virtual marker is farthest from the user's vehicle. In this way, the display position of the virtual marker is controlled such that the virtual marker fades out to the user's vehicle or fades in from the user's vehicle in accordance with the inter-vehicle distance.

Although an arbitrary method may be employed for changing the display position of the virtual marker, a plurality of image data for different virtual markers for different inter-vehicle distances are provided and one of the image data corresponding to an inter-vehicle distance is selected according to an embodiment. The individual image data renders images of the virtual markers in determined coordinate positions in individual frames. For example, an image of a virtual marker is rendered in a coordinate position on a near side of a frame in a case of image data corresponding to a short inter-vehicle distance whereas an image of a virtual marker is rendered in a coordinate position on a far side of a frame in a case of image data corresponding to a long inter-vehicle distance. Furthermore, in a case where a portion of the virtual image of the virtual marker is not displayed, the other portion of the image of the virtual marker is rendered, whereas in a case where the entire virtual image of the virtual marker is not displayed, the image of the virtual marker is completely deleted. However, such an image of a virtual marker may be generated in real time in accordance with an inter-vehicle distance instead of such a plurality of image data provided in advance. Furthermore, as another embodiment, the controller 160 may control a projection angle and a focal length of the projection optical system 134 through the actuator 135 based on an inter-vehicle distance so as to change the display position of the virtual marker.

The display size determination unit 240 determines a size of the virtual marker based on the inter-vehicle distance. The display size determination unit 240 increases a size of the virtual marker when the forward vehicle is viewed large due to approach of the forward vehicle as the inter-vehicle distance is reduced and reduces the size of the virtual marker when the forward vehicle is viewed small as the inter-vehicle distance is increased. As a preferred embodiment, a display size of the virtual marker is controlled such that the size of the virtual marker is increased in a step-by-step manner as the inter-vehicle distance is reduced and the size of the virtual marker is reduced in a step-by-step manner as the inter-vehicle distance is increased.

Although an arbitrary method may be employed for changing a display size, in a case where image data for a virtual marker corresponding to an inter-vehicle distance is provided or generated as described above, an image size of the virtual marker rendered in a frame is differentiated depending on the inter-vehicle distance according to an embodiment. Furthermore, as another embodiment, the controller 160 may control a projection angle and a focal length of the projection optical system 134 through the actuator 135 based on the inter-vehicle distance so as to change the display size of the virtual marker.

As another preferred embodiment, the display size determination unit 240 determines a size of the virtual marker based on a size of the forward vehicle detected by the forward vehicle detector 210. For example, different types of forward vehicle (a bus, a truck, a standard-sized car, a light vehicle, a two-wheel vehicle, and the like) have different sizes even if the inter-vehicle distance is the same. If the size of the forward vehicle is large, the size of the virtual marker is large, whereas if the size of the forward vehicle is small, the size of the virtual marker is small. In this way, a feeling of strangeness caused by mismatch between the size of the forward vehicle and the size of the virtual marker may be eliminated.

The projection controller 250 controls the HUD 130 such that the virtual marker is projected in accordance with the display position determined by the display position determination unit 230 and the display size determined by the display size determination unit 240. Specifically, the projection controller 250 controls image data for the virtual marker to be supplied to the optical modulation unit 133 and controls projection of the projection optical system 134 through the actuator 135. By this, an image of the virtual marker is projected on a windshield 136 by the projection optical system 134, and the driver may visually recognize the virtual image D of the virtual marker which guides the user's vehicle and which overlaps with the real space while overlap with the forward vehicle X is avoided as illustrated in FIG. 4A.

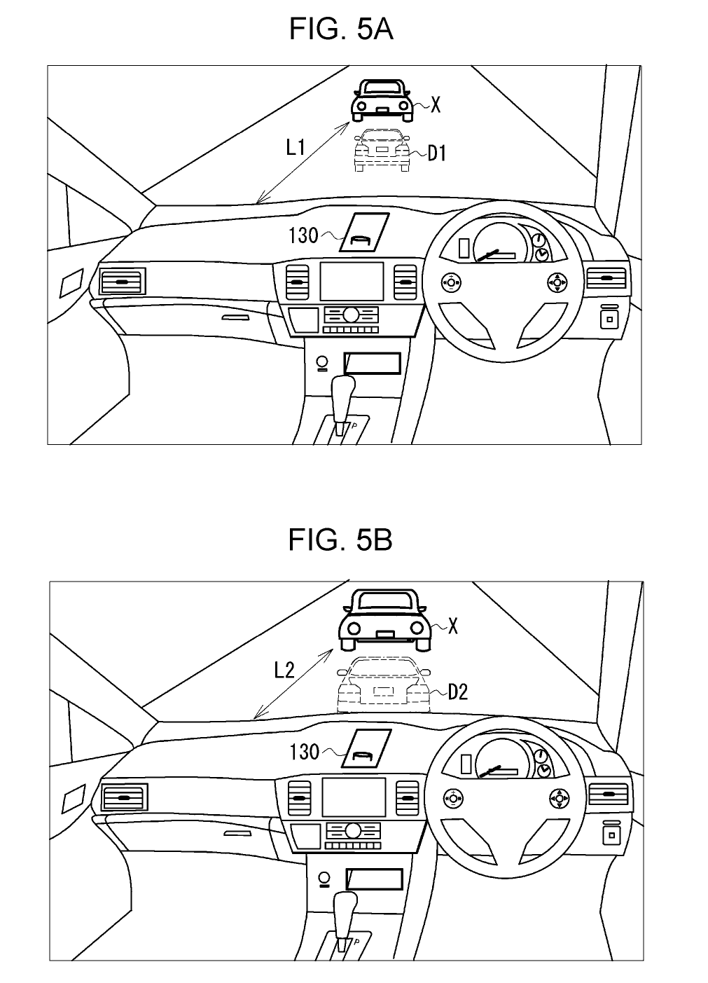

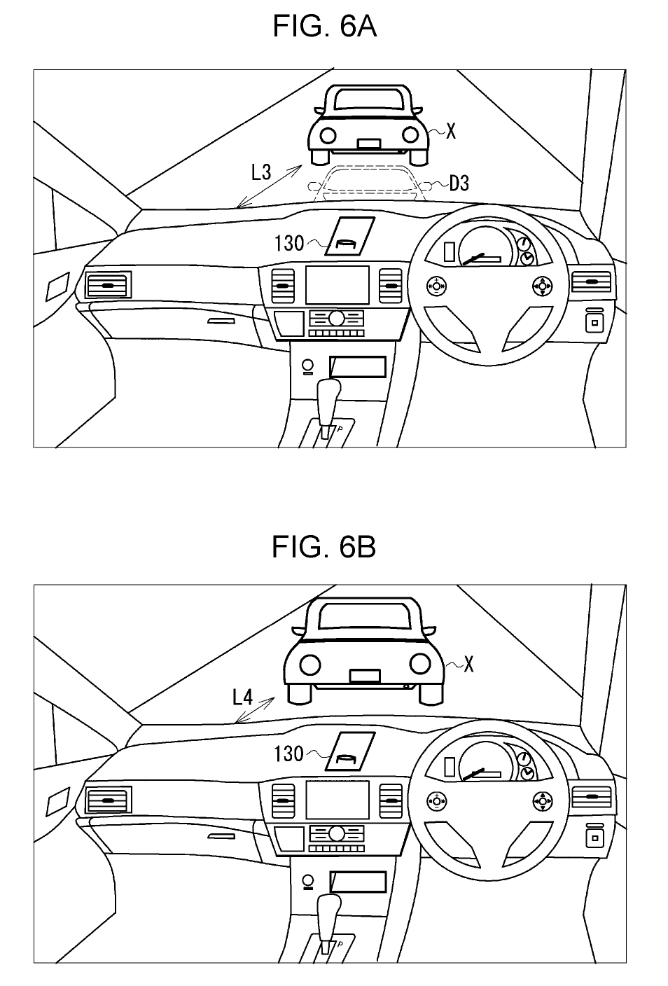

FIGS. 5A and 5B and FIGS. 6A and 6B are diagrams illustrating examples of display of the virtual marker when the inter-vehicle distance between the forward vehicle and the user's vehicle is gradually reduced. In FIG. 5A, in a case of the inter-vehicle distance L1 between the user's vehicle and the forward vehicle X, a virtual image D1 of a virtual marker is displayed on a rear side relative to the forward vehicle X. In FIG. 5B, the inter-vehicle distance is reduced to the inter-vehicle distance L2 (L2<L1), and accordingly, a virtual image D2 of the virtual marker is shifted to a near side of the user's vehicle and a size of the virtual image D2 is considerably increased. As illustrated in FIG. 6A, when the inter-vehicle distance is further reduced to the inter-vehicle distance L3 (L3<L2), the rear portion of a virtual image D3 of the virtual marker overlaps with the user's vehicle M, and therefore, an overlapping portion of the virtual image D3 of the virtual marker is not displayed as if the virtual marker is absorbed into the user's vehicle. Furthermore, as illustrated in FIG. 6B, the inter-vehicle distance is further reduced to an inter-vehicle distance L4 (L4<L3), the entire virtual image of the virtual marker is not displayed, that is, the virtual marker disappears. On the other hand, when the inter-vehicle distance is increased, the virtual image of the virtual marker is displayed in order from FIG. 6B, FIG. 6A, FIG. 5B, and FIG. 5A.

According to this embodiment, the display position of the virtual marker is changed depending on the inter-vehicle distance between the user's vehicle and the forward vehicle so that excellent visibility of the virtual marker for the driver is ensured. Furthermore, the virtual marker may fade in or fade out in accordance with the inter-vehicle distance, and accordingly, display and non-display of the virtual marker may be smoothly changed and the visibility of the virtual marker may be improved.

Note that, although the size of the virtual marker is changed in accordance with the inter-vehicle distance according to the embodiment, this is not essential and the size of the virtual marker may be constant. Furthermore, the projection controller 250 brings the virtual marker in the non-display state when the inter-vehicle distance L4 becomes equal to or smaller than a certain value as illustrated in FIG. 6B, and in addition, the projection controller 250 preferably brings the virtual marker into a non-display state when the user's vehicle is stopped. In this case, the inter-vehicle distance between the user's vehicle and the forward vehicle X is not related. When the user's vehicle is stopped, the display of the virtual marker may not be useful for the driver but merely a distraction.

Next, another embodiment different from the embodiment above will be described. In this embodiment, a virtual marker is displayed taking a direction of a face or a viewing direction of a driver into consideration. The controller 160 detects the direction of the face or the viewing direction of the driver based on the image data obtained by imaging the face of the driver supplied from the imaging camera 110. The display position determination unit 230 adjusts the display position of the virtual marker taking the detected direction of the face or the detected viewing direction of the driver into consideration.

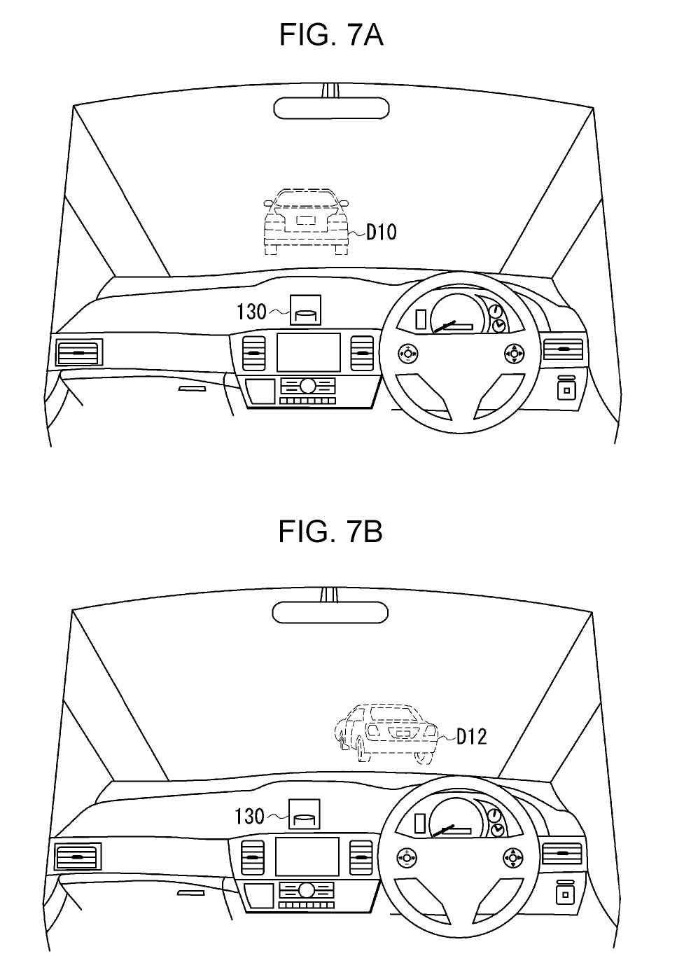

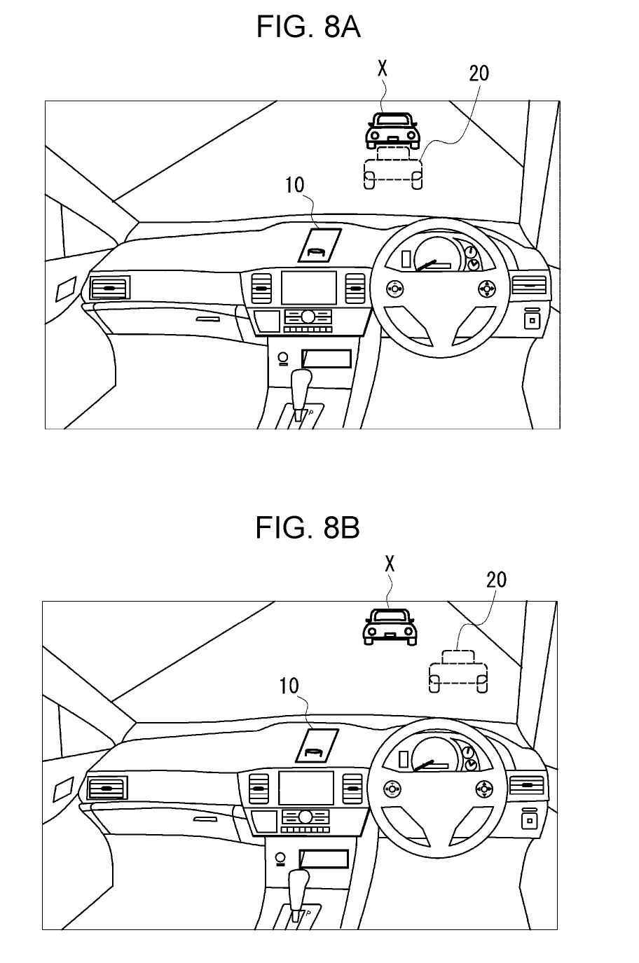

When the viewing direction of the drive indicates a forward direction, a virtual image D10 of the virtual marker is displayed in the viewing direction as illustrated in FIG. 7A. When the viewing direction of the drive indicates a rightward direction, a virtual image D12 of the virtual marker is displayed in the viewing direction as illustrated in FIG. 7B. In this case, the controller 160 supplies a three-dimensional image of the virtual marker corresponding to the virtual image D12 of the virtual marker to the optical modulation unit 133 such that a side of the vehicle of the virtual image D12 is viewed.

According to this embodiment, the three-dimensional virtual marker may be displayed in a position corresponding to the direction of the face or the viewing direction of the driver. Although the virtual marker has a shape of a vehicle, for example, in the foregoing embodiment, this is merely an example, and the virtual marker may have a shape other than a vehicle shape.

According to the present disclosure, a position where a virtual image of a virtual marker is displayed is variable in accordance with an inter-vehicle distance between the user's vehicle and a forward vehicle so that excellent visibility of the virtual marker is ensured. Furthermore, in a case where the virtual image of the virtual marker overlaps with the user's vehicle due to reduction of the inter-vehicle distance, an overlapping portion is not displayed so that visibility of the virtual marker is further improved.

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teachings of the invention without departing from the central scope thereof. Therefore, it is intended that this invention not be limited to the particular embodiments disclosed, but that the invention will include all embodiments falling within the scope of the appended claims.

What is claimed is:

1. A display system of a head-up display, comprising:
an object detector configured to detect a forward vehicle which is traveling in front of the user's vehicle;
an inter-vehicle distance measurement unit configured to measure an inter-vehicle distance between the user's vehicle and the forward vehicle;
a head-up display configured to project an image of a virtual marker which guides a traveling direction of the user's vehicle on a windshield of the user's vehicle; and
a projection controller configured to control the head-up display such that a display position of a virtual image of the virtual marker is changed depending on the inter-vehicle distance.

2. The display system according to claim 1, wherein the projection controller shifts a display position of the virtual image of the virtual marker toward a near side as the inter-vehicle distance is reduced.

3. The display system according to claim 2, wherein the projection controller does not display a portion of the virtual image of the virtual marker when the inter-vehicle distance becomes equal to or smaller than a first value.

4. The display system according to claim 3, wherein the projection controller does not display a portion of the virtual image of the virtual marker which overlaps with the user's vehicle.

5. The display system according to claim 4, wherein the projection controller does not display the entire virtual image of the virtual marker when the inter-vehicle distance becomes equal to or smaller than a second value which is smaller than the first value.

6. The display system according to claim 1, wherein the projection controller changes a size of the virtual marker in a step-by-step manner in accordance with the inter-vehicle distance.

7. The display system according to claim 5, wherein the projection controller changes a size of the virtual marker in a step-by-step manner in accordance with the inter-vehicle distance.

8. The display system according to claim 6, wherein the projection controller determines the size of the virtual marker based on a size of the forward vehicle detected by the object detector.

9. The display system according to claim 7, wherein the projection controller determines the size of the virtual marker based on a size of the forward vehicle detected by the object detector.

10. The display system according to claim 1, wherein the projection controller does not display the virtual image of the virtual marker irrespective of a degree of the inter-vehicle distance when the user's vehicle is stopped.

11. The display system according to claim 8, wherein the projection controller does not display the virtual image of the virtual marker irrespective of a degree of the inter-vehicle distance when the user's vehicle is stopped.

12. The display system according to claim 9, wherein the projection controller does not display the virtual image of the virtual marker irrespective of a degree of the inter-vehicle distance when the user's vehicle is stopped.

13. The display system according to claim 2, wherein the virtual marker is an image indicating a vehicle shape, and a rear portion of the vehicle shape is not displayed.

14. A display system of a head-up display, comprising:
an object detector configured to detect a forward vehicle which is traveling in front of the user's vehicle;
an inter-vehicle distance measurement unit configured to measure an inter-vehicle distance between the user's vehicle and the forward vehicle;
a head-up display configured to project an image of a virtual marker which guides a traveling direction of the user's vehicle on a windshield of the user's vehicle;
a projection controller configured to control the head-up display such that a display position of a virtual image of the virtual marker is changed depending on the inter-vehicle distance; and
an imaging camera configured to detect a viewing direction or a face direction of a driver,
wherein the projection controller controls a position where the virtual image of the virtual marker is displayed based on a result of the detection performed by the imaging camera.

15. The display system according to claim 14, wherein the projection controller shifts a display position of the virtual image of the virtual marker toward a near side as the inter-vehicle distance is reduced.

16. The display system according to claim 15, wherein the projection controller does not display a portion of the virtual image of the virtual marker when the inter-vehicle distance becomes equal to or smaller than a first value.

17. The display system according to claim 16, wherein the projection controller does not display a portion of the virtual image of the virtual marker which overlaps with the user's vehicle.

18. The display system according to claim 14, wherein the projection controller changes a size of the virtual marker in a step-by-step manner in accordance with the inter-vehicle distance.

19. The display system according to claim 18, wherein the projection controller determines the size of the virtual marker based on a size of the forward vehicle detected by the object detector.

20. The display system according to claim 19, wherein the projection controller does not display the virtual image of the virtual marker irrespective of a degree of the inter-vehicle distance when the user's vehicle is stopped.
